(19) United States
(12) Patent Application Publication
(10) Pub. No.: US 2019/0185725 A1
(43) Pub. Date: Jun. 20, 2019

(54) ASPHALT COMPOSITIONS AND METHODS OF USING THE SAME

(71) Applicant: HONEYWELL INTERNATIONAL INC., Morris Plains, NJ (US)

(72) Inventors: Yonghong Ruan, Wayne, NJ (US); Ruixing Yuan, Shanghai (CN); Scott Martin Hacker, River Edge, NJ (US)

(73) Assignee: HONEYWELL INTERNATIONAL INC., Morris Plains, NJ (US)

(21) Appl. No.: 16/192,016

(22) Filed: Nov. 15, 2018

Related U.S. Application Data
(60) Provisional application No. 62/598,762, filed on Dec. 14, 2017.

(51) Int. Cl. C09J 195/00; C09J 11/06; C09J 11/08

(52) U.S. Cl. CPC C09J 195/00; C08L 55/005; C09J 11/08; C09J 11/06

(57) ABSTRACT

Asphalt adhesive compositions and methods of producing the same are provided. In an exemplary embodiment, an asphaltic adhesive useful for self-adhering membranes includes asphalt at from about 40 to about 70 weight percent, based on a total weight of the adhesive. The adhesive also includes a low molecular weight (LMW) polyolefin at from about 1 to about 10 weight percent, based on the total weight of the adhesive. The LMW polyolefins have a weight average molecular weight (M_{w}) of from about 500 to about 20,000 Daltons. The adhesive has an aged peeling strength greater than an aged peeling strength of a comparable comparison adhesive, wherein the comparison adhesive includes from about 40 to about 70 weight percent asphalt but is free of a LMW polyolefin, as determined by Guobiao recommended (GB/T) 328.20-2007 in specification Guobiao (GB) 23441-2009 (self-adhering polymer modified bituminous waterproof sheet.)

This application claims the benefit of U.S. Provisional Application No. 62/598,762, filed Dec. 14, 2017.

### TECHNICAL FIELD

The present disclosure generally relates to asphalt compositions and methods of making and using the same. More particularly, the asphalt compositions comprise bitumen and a polymer, where the asphalt compositions are useful as adhesives for membranes or other applications.

### BACKGROUND

Asphalt based adhesives have been widely used in construction and as building materials, such as for paving, for roofing and for waterproofing products. Two primary types of asphalt roofing products include asphalt roofing shingles and modified asphalt roofing membranes. Asphalt based adhesives are also utilized in other applications such as road and bridge building.

For asphalt roofing shingles, asphalt based adhesives may be used to adhere multiple shingle pieces into a single piece to produce a laminate shingle, such as at a shingle manufacturing plant. Asphalt based adhesives are also applied to shingle tab surface which can be thermally activated by sunlight or ambient temperature on a roof to form an adhesive seal. The asphalt based adhesive should have good adhesion during installation, and it should maintain its adhesion performance over time. Many currently available asphalt based adhesives have limited adhesion during installation such that a shingle will delaminate. Furthermore, a shingle with current asphalt based adhesives and/or sealants may fail to properly form a seal on a roof deck, so the roof may leak or the shingle may delaminate during a wind storm or during other stress periods. Furthermore, hot summer periods tend to cause reduced adhesion for many current asphalt based adhesives. The adhesion also tends to drop dramatically over time, especially when exposed to alternating hot and cold periods typically experienced by roofing materials.

A modified asphalt roofing membrane (sometimes also called “mod-bit”) may be made by encapsulating a substrate (polyester mat, fiberglass mat, etc.) with an asphalt composition. The asphalt composition may be modified with a polymer, such as styrene/butadiene/styrene copolymer (SBS) and/or atactic polypropylene (APP), to improve performance. The modified asphalt roofing membrane can be installed on a roof deck by hot asphalt mopping, cold adhesive application processes, and heat welding. Recently a new type of modified asphalt roofing membrane product, called a “self-adhering” roofing membrane, has gained in popularity due to ease of installation. The self-adhering roofing membrane includes a thin layer of an asphalt adhesive compound coated on the bottom of the roofing membrane so the roofing membrane adheres to the roof deck without additional adhesive materials (such as hot asphalt mopping materials or additional cold adhesive materials,) and without additional installation processes, such as heat welding. However, current asphalt based adhesives used with self-adhering roofing membranes provide limited adhesion performance during installation, and also exhibit reduced adhesion performance over time.

Accordingly, it is desirable to provide asphalt compositions with good adhesion during manufacture, during installation, and over time. In addition, it is desirable to produce asphalt compositions with high bond strength and deformation resistance. Furthermore, other desirable features and characteristics of the present embodiment will become apparent from the subsequent detailed description and the appended claims, taken in conjunction with the accompanying drawings and this background.

### BRIEF SUMMARY

Asphalt adhesive compositions and methods of producing the same are provided. In an exemplary embodiment, an asphaltic adhesive useful for self-adhering membranes includes asphalt at from about 40 to about 70 weight percent, based on a total weight of the adhesive. The adhesive also includes a low molecular weight (LMW) polyolefin at from about 1 to about 10 weight percent, based on the total weight of the adhesive. The LMW polyolefins have a weight average molecular weight (M_{w}) of from about 500 to about 20,000 Daltons. The adhesive has an aged peeling strength greater than an aged peeling strength of a comparable comparison adhesive, wherein the comparison adhesive includes from about 40 to about 70 weight percent asphalt, based on a total weight of the comparison adhesive, but wherein the comparison adhesive is free of a LMW polyolefin, wherein the aged peeling strength is determined by Guobiao recommended (GB/T) 328.20-2007 in specification Guobiao (GB) 23441-2009 (self-adhering polymer modified bituminous waterproof sheet.)

An adhesive is provided in another embodiment. The adhesive includes asphalt at from about 85 to about 97.5 weight percent, based on a total weight of the adhesive. The adhesive also includes a polymer at from about 2.5 to about 15 weight percent, based on the total weight of the adhesive. The polymer includes one or more of a low molecular weight (LMW) polyolefin and an elastomer, where the LMW polyolefin has a weight average molecular weight (M_{w}) of from about 500 to about 20,000 Daltons. The adhesive has a bond strength greater than a comparison adhesive that includes asphalt at from about 85 to about 97.5 weight percent, based on a total weight of the comparison adhesive, wherein the comparison adhesive is free of a LMW polyolefin. The bond strength is determined by ASTM D 1970 at 25 degrees Celsius.

A method of producing an asphalt adhesive is provided in yet another embodiment. The method includes mixing asphalt with a low molecular weight (LMW) polyolefin and with additional additives, where the low molecular weight polyolefin has a weight average molecular weight (M_{w}) of from about 500 to about 20,000 Daltons. The mixing is performed at a temperature of from about 75° C. to about 200° C. for a time period of from about 30 minutes to about 8 hours.

### DETAILED DESCRIPTION

The following detailed description is merely exemplary in nature and is not intended to limit the various embodiments or the application and uses of the embodiments described herein. Furthermore, there is no intention to be bound by any expressed or implied theory presented in the preceding technical field, background, brief summary, or the following detailed description.

Novel asphalt compositions and methods of making the same are provided and described herein. It has been found that the addition of certain polymer(s) to asphalt adhesives increases the adhesion strength, and in particular increases the aged adhesion strength. The addition of certain polymer(s) has also been found to increase the bond strength and deformation resistance of asphalt adhesives. The improved properties of the asphalt compositions depend on the concentration of the polymer(s), where too little or too much of the polymer(s) reduces the desired properties. In other words, the concentration of the polymer(s) can be optimized for maximum performance Better performance can translate into a longer life span for the product, and that will bring significant economic benefits to customers.

In an exemplary embodiment, an asphaltic adhesive useful for self-adhering membrane applications comprises asphalt and a polymer, where the polymer comprises one or more of a low molecular weight polyolefin and one or more elastomers, such as styrene/butadiene/styrene copolymer (SBS) and styrene/isoprene/styrene copolymer (SIS). An asphalt adhesive useful for roofing shingle laminate adhesive and/or roofing shingle tab adhesive purposes (referred to herein as the asphalt useful for shingles) comprises asphalt and a polymer, where the polymer comprises one or more of a low molecular weight polyolefin and an elastomer, such as styrene/butadiene/styrene copolymer (SBS). The low molecular weight polyolefins have a weight average molecular weight (M_{w}) of from about 500 to about 20,000 Daltons.

The term “asphalt,” as used herein, is as defined by the ASTM and is a dark brown to black cement-like material in which the predominant constituents are bitumens that occur in nature or are obtained in petroleum processing. Asphalts characteristically contain saturates, aromatics, resins and asphaltenes. The terms “asphalt” and “bitumen” are often used interchangeably to mean both natural and manufactured forms of the material, which are all within the scope of the compositions and methods contemplated and described herein. Hereinafter, only the term “asphalt” will be used to describe suitable asphalt and bitumen materials.

The type of asphalt suitable for use in the compositions and methods contemplated and described herein are not particularly limited and include any naturally occurring, synthetically manufactured and modified asphalts known now or in the future. Naturally occurring asphalt is inclusive of native rock asphalt, lake asphalt, and the like. Synthetically manufactured asphalt is often a byproduct of petroleum refining operations and includes air-blown asphalt, blended asphalt, cracked or residual asphalt, petroleum asphalt, propane asphalt, straight-run asphalt, thermal asphalt, and the like. Modified asphalt includes base asphalt (e.g., neat or unmodified asphalt that can be naturally occurring or synthetically manufactured) modified with elastomers, processing oils, tackifiers, phosphoric acid, polyphosphoric acid, plastomers, ground tire rubber (GTR), reclaimed asphalt pavement (RAP), reclaimed asphalt shingles (RAS), and the like, or various combinations of these modifiers.

Furthermore, industry-grade asphalts, including without limitation, paving-grade asphalts, are advantageous for use in the compositions and methods contemplated and described herein. Non-exclusive examples of paving-grade asphalts include, but are not limited to, asphalts having any one of the following performance grade ratings: PG 46-34, PG 52-34, PG 52-28, PG 58-28, PG 64-22, PG 64-16, PG 64-10, PG 67-22, PG 70-28, PG 70-22, PG 70-16, PG 70-10, PG 76-28, PG 76-22, PG 76-16 and PG 76-10. Additionally, non-exclusive examples of paving-grade asphalts within the scope of the present disclosure include, but are not limited to, paving-grade asphalts having any one of the following penetration grades: 50/70, 60/90, 70/100, 80/110, and 120/150.

Additionally, it is contemplated that industry-grade asphalts, such as roof-grade asphalts, may be advantageously used in the asphalt compositions contemplated and described herein. In such embodiments, the asphalt binder compositions will be useful for roofing applications. Suitable roofing-grade asphalts include, but not limited to, asphalts having any one of the following hardness grades: 50/70 deci-millimeters penetration (dmm pen), 60/90 dmm pen, 70/100 dmm pen, 80/110 dmm pen, 120/150 dmm pen, 100/150 dmm pen, 150/200 dmm pen, 200/300 dmm pen, and 300+ dmm pen. Hardness grades are determined per the test method described in ASTM D5. In some embodiments of the asphalt composition, the asphalt is present at a concentration of from about 40 to about 98 weight % (wt. %), based on the total weight of the asphalt composition. All weight percents described herein are based on the total weight of the asphalt composition unless specifically stated otherwise. Asphalt may be present at different concentrations in the different asphaltic adhesive compositions described herein (i.e., the asphaltic adhesive compositions (i) useful for self-adhering membranes and (ii) useful shingles.) For example, in the asphaltic adhesive compositions useful for self-adhering membranes, the asphalt may be present at a concentration of from about 50 to about 60 wt. %, or from about 51 to about 57 wt. %, or from about 53 to about 55 wt. %. In the asphaltic adhesive useful for shingles, the asphalt may be present at a concentration of from about 85 to about 97.5 wt. %, or from about 88 to about 95 wt. %, or from about 92 to about 94 wt. %.

The “membrane” for the asphaltic adhesive useful for self-adhering membranes may be a wide variety of materials. In some embodiments, the membrane may include a substrate such as fiberglass mat, polyester mat, or other materials. The asphaltic adhesive layer may be just a portion of the self-adhering membrane, but in some embodiments the membrane primarily includes the asphaltic adhesive itself, so the adhesive primarily forms the membrane. As used herein, a material “primarily” includes a compound if that compound is about 50 weight percent or more of the material.

The asphalt compositions described herein include one or more low molecular weight (LMW) polyolefins in amounts from about 0.5 to about 10 wt. %, based on the total weight of the asphalt composition. “Low Molecular Weight (LMW) polyolefin,” as this term is used herein, means a polyolefin-containing polymer, or a blend of two or more polyolefin-containing polymers, each of which has a weight average molecular weight (M_{w}) of from about 500 to about 20,000 Daltons, and comprises one or more olefinic monomers, where the olefinic monomers are selected from: ethene, propene, butene, hexene, and octene. Thus, the LMW polyolefins may be homopolymers comprising only a single type of olefin monomer, or copolymers comprising two or more types of olefin monomers. Furthermore, LMW polyolefins, as this term is used herein, include but are not limited to polyolefin waxes, i.e., polyolefins which are solid at or near room temperature and have low viscosity when above their melting point.

The LMW polyolefins may be functionalized in some embodiments, where the LMW polyolefin may be a functionalized homopolymer or a copolymer. In an exemplary embodiment, functionalized LMW polyolefins comprise one or more functional groups including for example, without limitation, an acid, an ester, an amine, an amide, an ether, and an anhydride such as maleic anhydride. Additionally, the LMW polyolefins may be oxidized.

In an exemplary embodiment, the LMW polyolefin has an olefin content of from about 50 to about 100 wt. %, based on the total weight of the LMW polyolefin. An exemplary LMW polyolefin has an olefin content in wt. %, based on the total weight of the LMW polyolefin, of at least about 55, 60, 65, 70, 75, 80, 85, 90, or 95 wt. %, and independently, of not more than about 100, 98, 95, 92, 90, 85, 80, or 75 wt. %.

As already mentioned, in an exemplary embodiment the LMW polyolefin has a M_{w} of from about 500 to about 20,000 Daltons. In various embodiments the LMW polyolefin has a M_{w} in Daltons of at least about 500, 1,000, 2,000, 3,000, 4,000, 5,000, 6,000, or 7,000, and independently, of not more than about 20,000, 18,000, 15,000, 12,000, or 10,000. Where the LMW polyolefin comprises a combination of more than one type of polyolefin, the M_{w} of each type of polyolefin in the combination may individually be within the above-stated range of about 500 to about 20,000 Daltons. The molecular weight of the LMW polyolefins of the present invention may be determined by gel permeation chromatography (GPC), which is a technique generally known in the art. For the purpose of GPC, the sample to be measured may be dissolved in 1,2,4-trichlorobenzene at about 140° C. and at a concentration of about 2.0 mg/ml. The solution (200 microliters (μL)) is injected into the GPC containing two PLgel 5 micrometer (μm) Mixed-D (300×7.5 mm) columns held at about 140° C. with a flow rate of about 1.0 mL/minute. The instrument may be equipped with two detectors, such as a refractive index detector and a viscosity detector. The molecular weight (weight average molecular weight, M_{w}) is determined using a calibration curve generated from a set of linear polyethylene narrow M_{w} standards.

Generally, suitable LMW polyolefins include, without limitation, polyethylene homopolymers, polypropylene homopolymers, copolymers of two or more of ethylene, propylene, butene, hexene and octene, functionalized derivatives of the homopolymers mentioned above, functionalized derivatives of the copolymers mentioned above, or combinations of unfunctionalized and functionalized LMW polyolefins. Some Fischer-Tropsch waxes, i.e., those that satisfy the above-defined characteristics of LMW polyolefins, may also be used in the asphalt compositions contemplated and described herein. Examples of suitable functionalized LMW polyolefins include, without limitation, maleated polyethylene, maleated polypropylene, ethylene acrylic acid copolymers, ethylene vinyl acetate copolymers, oxidized polyethylene, including oxidized high density polyethylene, and combinations thereof.

In exemplary embodiments, the LMW polyolefin is present in the asphaltic adhesives described herein at different concentrations. For example, the asphalt adhesive useful for self-adhering membranes may include one or more LMW polyolefins at from about 1 to about 10 weight percent, based on the total weight of the asphalt composition. In various embodiments, the LMW polyolefin is present in the asphalt adhesive composition in an amount, in wt. %, based on the total weight of the asphalt composition, of at least about 1, 2, 3, 4, 5, 6, 7, 8, 9, or 10 wt. % and independently, of not more than about 10, 9, 8, 7, 6, 5, 4, 3, 2, or 1 wt. %. For example, the total content of LMW polyolefin in the asphalt adhesive composition may be from about 1 to about 10 wt. %, or from about 2 to about 9 wt. %, or from about 3 to about 7 wt. %, based on the total weight of the asphalt composition. The asphalt adhesive useful for shingles may include one or more LMW polyolefins at from about 2.5 to about 15 wt. %, based on the total weight of the asphalt composition. In various embodiments, the LMW polyolefin is present in the asphaltic adhesive composition in an amount, in wt. %, based on the total weight of the asphalt composition of at least about 0.5, 1, 1.5, 2, 2.5, 3, 4, 5, 6, 7, 8, 9, 10, or 11 wt. % and independently, of not more than about 15, 14, 13, 12 11, 10, 9, 8, 7, 6, 5, 4, 3, 2, or 1.5 wt. %. For example, the total content of LMW polyolefin in the asphalt adhesive composition may be from about 1 to about 10 wt. %, or from about 1.5 to about 9 wt. %, or from about 2 to about 3 wt. %, based on the total weight of the asphalt composition.

Performance additives such as plastomers, elastomers, or both are well-known in the industry for use in asphalt compositions, and these additives may expand the temperature ranges at which asphalt compositions can be used without serious defect or failure. Plastomers and elastomers are jointly referred to herein as “polymers.” The asphalt compositions contemplated herein may comprise one or more polymers that are present in a total amount of from about 0.5 to about 30 wt. %, based on the total weight of the asphalt composition. Non-limiting examples of polymers suitable for modifying the asphalt compositions contemplated herein include natural or synthetic rubbers including ground tire rubber (GTR), devulcanized GTR, butyl rubber, styrene/butadiene rubber (SBR), styrene/ethylene/butadiene/styrene terpolymers (SEBS), polybutadiene, polyisoprene, ethylene/propylene/diene (EPDM) terpolymers, ethylene/n-butyl acrylate/glycidyl methacrylate terpolymers, and styrene/conjugated diene block or random copolymers, such as, for example, styrene/butadiene including styrene/butadiene/styrene copolymer (SBS), styrene/isoprene, styrene/isoprene/styrene (SIS) and styrene/isoprene-butadiene block copolymer. The block copolymers may be branched or linear and may be a diblock, triblock, tetrablock or multiblock. The LMW polyolefin is also a polymer and present in the asphalt compositions, as described above.

In some embodiments of the asphalt compositions contemplated and described herein, a polymer may be present in an amount of from about 0.5 to about 30 wt. %, based on the total weight of the asphalt composition. The quantity of polymer for the asphaltic adhesive useful for self-adhering membranes may be different than the quantity of polymer in the asphalt adhesive useful for shingles. The adhesive useful for self-adhering membranes may include a total quantity of polymer from about 10 to about 30 wt. %, based on the total asphalt adhesive composition. An exemplary polymer that may be used for the adhesive useful for self-adhering membranes includes the LMW polyolefin described above, and also includes one or more additional polymers at from about 10 to about 20 wt. %. For example, in some embodiments, the polymer(s) (excluding the LMW polyolefin) are present in the asphaltic adhesive composition useful for self-adhering membranes in an amount, in wt. %, based on the total weight of the asphalt composition, of at least about 10, 12, 14, 15, 16, 17, 18, 19, 20, 21, 23, 25, or 27 and independently, of not more than about 30, 27, 25, 23, 21, 20, 19, 18, 17, 16, 15, or 14. In an exemplary embodiment, the polymer(s), excluding the LMW polyolefin, include an SBS copolymer and an SIS copolymer. The SBS and SIS copolymers may be present in an amount of, for example without limitation, from about 10 to about 27 wt. %, or from about 14 to about 20 wt. %, or from about 16 to about 18 wt., based on the total weight of the asphalt adhesive composition.

The asphalt adhesive composition useful for shingles may include a polymer in addition to the LMW polyolefin, where the total concentration of polymer (including the LMW polyolefin) is from about 2.5 to about 15 wt. %, or from about 4 to about 12 wt. %, or from about 5 to about 10 wt. %, or from about 6 to about 8 wt. %, or at about 7 wt. %, all based on the total weight of the adhesive. In an exemplary embodiment, the polymers in the asphalt adhesive composition useful for shingles include the LMW polyolefin and an SBS copolymer, but polymers other than SBS copolymer may be used in conjunction with the LMW polyolefin in some embodiments. In yet other embodiments, the total concentration of polymer in the asphalt adhesive composition useful for shingles includes LMW polyolefin and two or more other polymers. The total polymer in the asphalt adhesive composition may be from about 10 to about 45 weight percent LMW polyolefin in some embodiments, based on the total weight of polymer in the asphaltic adhesive composition, but LMW polyolefin may be present at a concentration of from about 12 to about 35 wt. %, or from about 13 to about 30 wt. %, or from about 14 to about 29 wt. % in various embodiments.

The asphalt compositions contemplated herein may include additional additives in some embodiments. Non-exclusive examples of such additives suitable for inclusion in the asphalt compositions contemplated and described herein include, without limitation, plastomers, waxes (where the waxes may also be polymers), polyphosphoric acids, flux oils, plasticizers, anti-oxidants, tackifiers, processing aids, UV protecting additives, etc. Exemplary waxes include ethylene bis-stearamide wax (EBS), Fischer-Tropsch wax (FT), oxidized Fischer-Tropsch wax (FTO), polyolefin waxes such as polyethylene wax (PE), oxidized polyethylene wax (OxPE), polypropylene wax, polypropylene/polyethylene wax, alcohol wax, silicone wax, petroleum waxes such as microcrystalline wax or paraffin, and other synthetic waxes. Exemplary plasticizers include hydrocarbon oils (e.g., paraffin, aromatic and naphthenic oils), long chain alkyl diesters (e.g., phthalic acid esters, such as dioctyl phthalate, and adipic acid esters, such as dioctyl adipate), sebacic acid esters, glycol, fatty acid, phosphoric and stearic esters, epoxy plasticizers (e.g., epoxidized soybean oil), polyether and polyester plasticizers (which may also be polymers), alkyl monoesters (e.g., butyl oleate), long chain partial ether esters (e.g., butyl cellosolve oleate), and others. Exemplary tackifiers include rosins and their derivatives; terpenes and modified terpenes; aliphatic, cycloaliphatic and aromatic resins (C5 aliphatic resins, C9 aromatic resins, and C5/C9 aliphatic/aromatic resins); hydrogenated hydrocarbon resins; terpene-phenol resins; and combinations thereof.

In an exemplary embodiment, the asphaltic adhesive compositions useful for self-adhering membranes contemplated herein include at least a tackifier and a plasticizer, where the additives excluding polymers comprise from about 5 to about 35 wt. %, or from about 15 to about 30 wt. %, or from about 25 to about 28 wt. % of the asphalt adhesive composition in various embodiments. Other concentrations are also possible. Other additives are also possible. In an exemplary embodiment, the asphaltic adhesive useful for self-adhering membranes comprises a plasticizer at from about 15 to about 20 wt. %, or about 16 to 19 wt. %, or about 16 to 18 wt. %, and a tackifier at from about 5 to about 15 wt. %, or from about 7 to 13 wt. %, or from about 8 to about 10 wt. %, all based on the total weight of the adhesive. In one exemplary embodiment, the plasticizer is a naphthenic oil, and the tackifier is a terpene resin. In some embodiments, the asphaltic adhesive compositions useful for shingles contemplated herein include, excluding polymers, from about 0 to about 10 wt. %, or from about 0 to about 5 wt. %, or from about 0 to about 2 wt. % additives, based on the total weight of the asphaltic composition.

The asphalt adhesive compositions useful for self-adhering membranes contemplated herein provide strong unaged peeling strength, measured at 23 degrees Celsius (° C.) and reported in Newtons per millimeter (N/mm). However, the asphalt adhesive compositions also provide strong aged peeling strength. In an exemplary embodiment, the peeling strength was measured for a membrane adhered to an aluminum surface. The unaged peeling strength and the aged peeling strength was determined by GB/T 328.20-2007 in specification GB 23441-2009 (self-adhering polymer modified bituminous waterproof sheet.) Aged peeling strengths of 4 N/mm or greater were determined in some embodiments, as well as aged peeling strengths of 4.5 N/mm or greater and 5 N/mm or greater with different embodiments of the asphaltic adhesive described above. The asphaltic adhesive compositions useful for self-adhering membranes as described above has a higher aged peeling strength than a comparison asphaltic adhesive that includes asphalt at from about 40 to about 70 weight percent, based on a total weight of the comparison adhesive, and wherein the comparison adhesive is free of low molecular weight polyolefins, wherein the adhesive and the comparison adhesive are compared when adhering a membrane to aluminum as determined by Guobiao recommended (GB/T) 328.20-2007 in specification Guobiao (GB) 23441-2009 (self-adhering polymer modified bituminous waterproof sheet.) The term “free of,” as used herein, means the named component is present at a maximum concentration of about 0.01 weight percent, based on the total weight of the composition.

The asphaltic adhesive compositions useful for shingles contemplated herein provided strong bond strengths with acceptable viscosities, where viscosities were measured at 163° C. Compositions as contemplated herein have measured bond strengths of 2.0 kilograms per square centimeter (Kg/cm²) or greater with viscosities of 600 centipoise (cPs) or less. In an exemplary embodiment, the asphaltic adhesive compositions useful for shingles has a bond strength of at least about 2.2 Kg/cm2, or about 2.0 Kg/cm2, or about 1.7 Kg/cm2, or about 1.5 Kg/cm2 in various embodiments, as determined by ASTM D 1970 at 25° C. The asphaltic adhesive compositions useful for shingles as described above has a bond strength that is at least higher than the bond strength for a comparison asphaltic adhesive that comprises asphalt at from about 85 to about 97.5 weight percent, based on a total weight of the comparison adhesive, wherein the comparison adhesive is free of low molecular weight polyolefins, and wherein the bond strength is determined by ASTM D 1970 at 25 degrees Celsius.

Also provided are methods of making and using the asphalt compositions described herein. Generally, the method for making asphalt compositions comprises mixing (i) the asphalt with (ii) all the additives present in the asphalt composition, in appropriate amounts to form any of the embodiments of the asphalt compositions described above. Alternatively, the asphalt compositions can be produced by adding the ingredients individually in different orders of addition. The mixing is performed at suitable temperatures and agitation to thoroughly mix the components. In some embodiments of the method, for example, the mixing is performed at a temperature of from about 75° C. to about 200° C. for a time of from about 30 minutes to about 8 hours. Furthermore, the mixing may be performed, for example, using a low or high shear mixer at a speed of from about 5 revolutions per minute (RPM) to about 5,000 RPM.

### Examples

Exemplary asphaltic adhesives useful for self-adhering membranes were prepared and tested, as described above. The results are listed below, where the all tests include 176 grams of a base composition, where the “base composition” includes: 100 grams (g) of base asphalt 50/70 pen; 30 grams (g) naphthenic oil; 21 grams SBS 792; 9 grams SIS 1105; and 16 grams terpene resin.

Asphalt Adhesive Useful for Self-Adhering Membrane Test Results

| | Peeling | Unaged | Aged |
|---|---|---|---|
| | adhesion | peeling | peeling |
| | failure | strength | strength |
| | time | (N/mm @ | (N/mm @ |
| | (minutes) | 23° C.) | 23° C.) |
| LMW polyolefin (0 grams) | 180 | 6.16 | 3.42 |
| Oxidized polyethylene | 190 | 4.1 | 4.07 |
| (5.43 grams) | | | |
| Oxidized polyethylene | 230 | 4.38 | 4.29 |
| (8.8 grams) | | | |
| Oxidized polyethylene | 130 | Not Determined | ND |
| (12.3 grams) | | (ND) | |
| Maleated polypropylene | 255 | 5.69 | 5.21 |
| (5.43 grams) | | | |
| Maleated polypropylene | 250 | ND | ND |
| (8.8 grams) | | | |
| Maleated polypropylene | 104 | ND | ND |
| (12.3 g) | | | |
| Polyethylene (5.3 grams) | 223 | 5.28 | 3.46 |
| Polyethylene (8.8 grams) | 337 | 5.36 | 3.76 |
| Polyethylene (12.3 grams) | 229 | 5.84 | 4.67 |

Exemplary asphaltic adhesives useful for shingles were prepared and tested, as described above. The results are listed below, where all the tests include 93 wt. % PG 64-22 base asphalt, and 7 weight percent polymer. The polymers included the listed LMW polyolefins (oxidized polyethylene, abbreviated as PO) and SBS (Kraton® D1101) (Kraton is a registered trademark.)

Asphalt Adhesives Useful for Shingles Test Results

| | 7% SBS, | 6% SBS, | 5% SBS, | 4% SBS, | 3% SBS, |
|---|---|---|---|---|---|
| | 0% PO | 1% PO | 2% PO | 3% PO | 4% PO |
| Bond | 1.83 | 2.24 | 2.23 | 1.72 | 1.34 |
| strength | | | | | |
| (Kg/cm²) | | | | | |
| Softening | 86.9 | 88.1 | 90.1 | 98.1 | 95.6 |
| point (° C.) | | | | | |
| Penetration | 37 | 35 | 34 | 27 | 28 |
| (dmm) | | | | | |
| % recovery | 45.4 | 61.1 | 60 | 69.6 | 67.5 |
| in 5 min. | | | | | |
| % recovery | 51 | 73.9 | 76 | 81.1 | 75.8 |
| in 2 hours | | | | | |
| Viscosity at | 885 | 563 | 545 | 488 | 385 |
| 163° C. | | | | | |
| (cPs) | | | | | |
| Dispersion | 8 | 8 | 6 | 3 | 4 |
| time (hours) | | | | | |

While several embodiments have been presented in the foregoing detailed description, it should be appreciated that a vast number of variations exist. It should also be appreciated that the embodiment or embodiments are only examples, and are not intended to limit the scope, applicability, or configuration of this disclosure in any way. Rather, the foregoing detailed description will provide those skilled in the art with a convenient road map for implementing various embodiments of the asphalt compositions, it being understood that various changes may be made in the function and arrangement of elements described without departing from the scope as set forth in the appended claims and their legal equivalents.

What is claimed is:

1. An adhesive comprising:
asphalt at from about 40 to about 70 weight percent, based on a total weight of the adhesive; and
low molecular weight (LMW) polyolefins at from about 1 to about 10 weight percent, based on the total weight of the adhesive, wherein the LMW polyolefins have a weight average molecular weight (M_{w}) of from about 500 to about 20,000 Daltons, wherein the adhesive has an aged peeling strength greater than the aged peeling strength of a comparison adhesive, wherein the comparison adhesive comprises asphalt at from about 40 to about 70 weight percent, based on a total weight of the comparison adhesive, and wherein the comparison adhesive is free of low molecular weight polyolefins, wherein the adhesive and the comparison adhesive are compared when adhering a membrane to aluminum as determined by Guobiao recommended (GB/T) 328.20-2007 in specification Guobiao (GB) 23441-2009 (self-adhering polymer modified bituminous waterproof sheet.)

2. The adhesive of claim 1 further comprising:
a plasticizer at from about 15 to about 20 wt. %, based on the total weight of the adhesive.

3. The adhesive of claim 2 wherein the plasticizer is a naphthenic oil.

4. The adhesive of claim 1 further comprising:
a tackifier at from about 5 to about 15 wt. %, based on the total weight of the adhesive.

5. The adhesive of claim 1 further comprising:
a polymer other than the LMW polyolefin at from about 10 to about 27 weight percent, based on the total weight of the adhesive.

6. The adhesive of claim 6 wherein the polymer other than the LMW polyolefin comprise styrene/butadiene/styrene copolymer (SBS) and styrene/isoprene/styrene (SIS).

7. The adhesive of claim 1 wherein the adhesive has an aged peeling strength of about 3.5 newtons per millimeter or more.

8. The adhesive of claim 1 wherein the adhesive has an aged peeling strength of about 4 newtons per millimeter or more.

9. The adhesive of claim 1 wherein the LMW polyolefin is selected from the group consisting of an oxidized polyethylene, a maleated polypropylene, and a polyethylene.

10. The adhesive of claim 1 wherein the LMW polyolefin comprises maleated polypropylene.

11. The adhesive of claim 1 further comprising a membrane, wherein the adhesive is applied to the membrane.

12. The adhesive of claim 1 further comprising a membrane, wherein the membrane primarily comprises the adhesive.

13. An adhesive comprising:
asphalt at from about 85 to about 97.5 weight percent, based on a total weight of the adhesive; and
a polymer at from about 2.5 to about 15 weight percent, based on the total weight of the adhesive, wherein the polymer comprises one or more of a low molecular weight (LMW) polyolefin having a weight average molecular weight (Mw) of from about 500 to about 20,000 Daltons, and an elastomer;
wherein the adhesive has a bond strength greater than a comparison adhesive, wherein the comparison adhesive comprises asphalt at from about 85 to about 97.5 weight percent, based on a total weight of the comparison adhesive, wherein the comparison adhesive is free of low molecular weight polyolefins, wherein the bond strength is determined by ASTM 1970 at 25 degrees Celsius.

14. The adhesive of claim 13 wherein the polymer is present in the adhesive at from about 1 to about 10 wt. %.

15. The adhesive of claim 13 wherein the elastomer comprises styrene/butadiene/styrene copolymer (SBS).

16. The adhesive of claim 13 wherein the polymer comprises about 14 to about 29 wt. % LMW polyolefin, based on the total weight of the polymer in the adhesive.

17. The adhesive of claim 13 wherein the bond strength is at least about 2.0 kilograms per square centimeter.

18. The adhesive of claim 13 wherein the polymer is present in the adhesive at from about 6 to about 8 wt. %, based on the total weight of the adhesive.

19. The adhesive of claim 13 wherein the adhesive has a viscosity of about 600 centipoise or less at a temperature of about 163 degrees Celsius.

20. A method of producing an asphalt adhesive comprising:
mixing an asphalt with a low molecular weight (LMW) polyolefin and with additional additives, where the low molecular weight polyolefin has a weight average molecular weight (Mw) of from about 500 to about 20,000 Daltons, wherein the mixing is performed at a temperature of from about 75° C. to about 200° C. for a time period of from about 30 minutes to about 8 hours.
